(19) United States
(12) Patent Application Publication
(10) Pub. No.: US 2007/0282967 A1
(43) Pub. Date: Dec. 6, 2007

(54) Method and system of a persistent memory

(76) Inventors: Samuel A. Fineberg, Pleasanton, CA (US); Pankaj Mehra, San Jose, CA (US); David J. Garcia, Cupertino, CA (US); William F. Bruckert, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/446,621

(22) Filed: Jun. 5, 2006

(51) Int. Cl. G06F 15/167; G06F 13/28

(52) U.S. Cl. 709/214; 710/22

(57) ABSTRACT

A method and system of implementing a persistent memory. At least some of the illustrative embodiments are a system comprising a first computer slice comprising a memory, a second computer slice comprising a memory (the second computer slice coupled to the first computer slice by way of a communication network at least partially external to each computer slice), and a persistent memory comprising at least a portion of the memory of each computer slice (the portion of the memory of the first computer slice storing a duplicate copy of data stored in the portion of the memory of the second computer slice). The persistent memory is accessible to an application program through the communication network.

### BACKGROUND

Network accessible persistent memory devices provide a mechanism for application programs to store data, which mechanism is resilient to single points of failure. For this reason, and possibly others, a persistent memory thus allows higher performance algorithms to use memory operations in lieu of disk operations.

### BRIEF DESCRIPTION OF THE DRAWINGS

For a detailed description of illustrative embodiments of the invention, reference will now be made to the accompanying drawings in which:

FIG. 1 illustrates a computing system in accordance with embodiments of the invention;

FIG. 2 illustrates a computing complex in accordance with embodiments of the invention; and

FIG. 3 illustrates a computing system in accordance with alternative embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

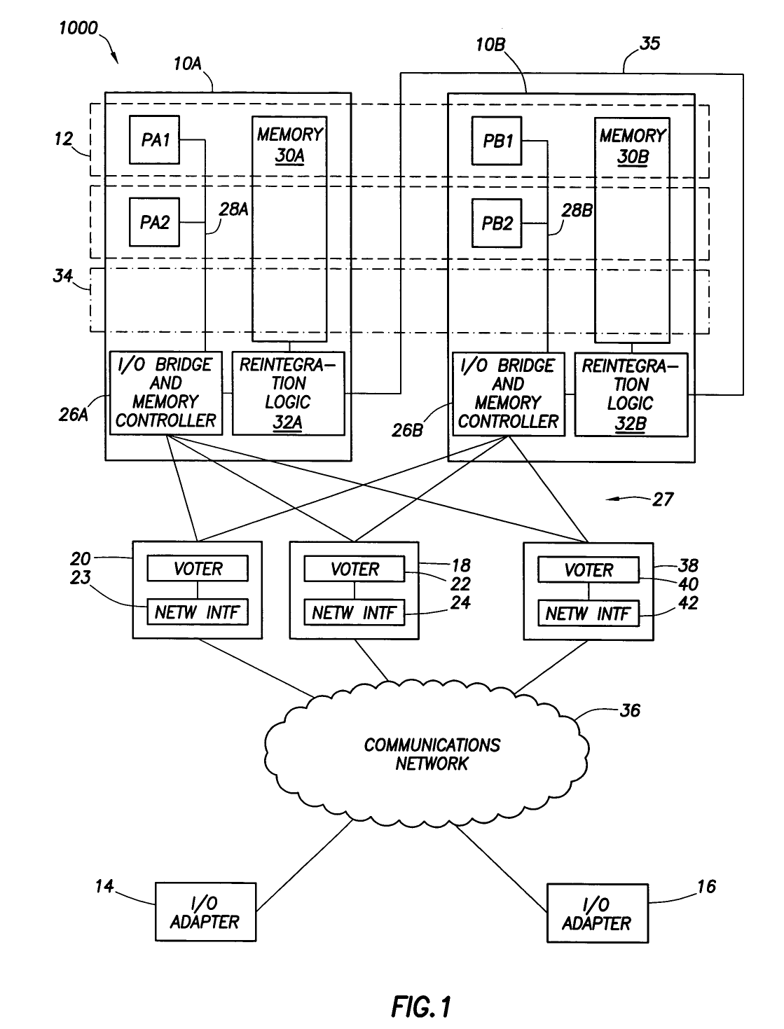

FIG. 1 illustrates a computing system 1000 in accordance with embodiments of the invention. In particular, the computing system 1000 comprises a plurality of multiprocessor computer systems 10, which may also be referred to as computer slices. In some embodiments, only two computer slices 10 are used, and as such the computing system 1000 may implement a dual-modular redundant (DMR) system. In further embodiments, the computing system 1000 may comprise three computer slices 10, and therefore implement a tri-modular redundant (TMR) system. Regardless of whether the computing system is dual-modular redundant or tri-modular redundant, the computing system 1000 implements application program fault tolerance, at least in part, by redundantly executing duplicate copies of an application program across multiple computer slices.

In accordance with some embodiments of the invention, each computer slice 10 comprises one or more processor elements, and as illustrated in FIG. 1, two processor elements. Each processor element of FIG. 1 has a leading “P.” Further, each processor element is given a letter designation of “A” or “B” to indicate the processor element's physical location within one of the computer slices 10A and 10B, respectively. Finally, each processor element is given a numerical designation to indicate that processor element's location within each computer slice. Thus, for example, the processor elements in computer slice 10A have designations “PA1” and “PA2.”

In accordance with some embodiments of the invention, at least one processor element from each computer slice 10 is logically grouped to form a logical processor. In the illustrative embodiments of FIG. 1, processor elements PA1 and PB1 are grouped to form logical processor 12 (indicated by dashed lines). Each processor element within a logical processor substantially simultaneously executes duplicate copies of an application program. More particularly, each processor element within a logical processor is provided the same instruction stream for the application program and computes the same results (assuming no errors). In some embodiments, the processor elements within a logical processor are in strict or cycle-by-cycle lock-step. In alternative embodiments, the processor elements are in lock-step, but not in cycle-by-cycle lock-step (being in lock-step, but not in cycle-by-cycle lock-step, is also known as loosely lock-stepped). In some embodiments, the processor elements have non-deterministic execution, and thus strict lock-step may not be possible. In the event one of the processor elements fails, the one or more remaining processor elements continue executing the application program.

Inasmuch as there may be two or more processor elements within a logical processor executing the same application program, duplicate reads and writes are generated, such as reads and writes to network interfaces 23 and 24. In order to compare the reads and writes for purposes of fault detection, each logical processor has an associated synchronization logic. For example, logical processor 12 is associated with synchronization logic 18. Likewise, the processor elements PA2 and PB2 form a logical processor associated with synchronization logic 20. Thus, each computer slice 10 couples to each of the synchronization logics 18 and 20 by way of an interconnect 27. The interconnect 27 is a Peripheral Component Interconnected (PCI) bus, and in particular a serialized PCI bus, although any bus or network communication scheme may be equivalently used.

Each synchronization logic 18 and 20 comprises a voter logic unit, e.g., voter logic 22 of synchronization logic 18. The following discussion, while directed to voter logic 22 of synchronization logic 18, is equally applicable to the voter logic unit of the synchronization logic 20. Consider for purposes of explanation each processor element in logical processor 12 executing its copy of an application program, and that each processor element generates a read request to network interface 24. Each processor element of logical processor 12 sends its read request to the voter logic 22. The voter logic 22 receives each read request, compares the read requests, and (assuming the read requests agree) issues a single read request to the network interface 24. The read request in some embodiments is a series of instructions programming a direct memory access (DMA) engine of the network interface 24 to perform a particular task. The data is read from the network interface 24 and the returned data is replicated and passed to each of the processor elements of the logical processor by the synchronization logic 18. Likewise, for other input/output functions, such as writes and transfer of packet messages to other programs (possibly executing on other logical processors), the synchronization logic ensures that the requests match, and then forwards a single request to the appropriate location. In the event one of the processor elements in the logical processor does not function properly (e.g., fails to generate a request, fails to generate a request within a specified time, generates a non-matching request, or fails completely), the offending processor element is voted out and the overall user program continues based on requests of the remaining processor element or processor elements of the logical processor.

Each of the processor elements may couple to an I/O bridge and memory controller 26 (hereinafter I/O bridge 26) by way of a processor bus 28. The I/O bridge 26 couples the processor elements to one or more memory modules of a memory 30 by way of a memory bus. Thus, the I/O bridge 26 controls reads and writes to the memory area and also allows each of the processor elements to couple to synchronization logics 18 and 20. FIG. 1 also shows that in some embodiments each computer slice 10 also comprises a reintegration logic 32 coupled between the I/O bridge 26 and the memory modules, with interconnections of the reintegration logics as between computer slices shown by bus 35. At times when all or part of the memory of a failed computer slice is not being replaced by that of a non-failed computer slice, the reintegration logic 56 is transparent to the I/O bridge 42, and does not interfere with reads and writes to the memory. However, in the event that a computer slice is newly inserted, a portion of the memory of the computer slice experiences a fault (such as the portion implementing a persistent memory as discussed below), or a processor element experiences a fault and needs to be reintegrated, the reintegration logic 32 enables copying of memory.

Still referring to FIG. 1, the memory 30, which may comprise one or more memory modules, is partitioned for use. In particular, the memory 30A of computer slice 10A may be partitioned into a plurality of partitions. Each processor element PA1 and PA2 is assigned and uses at least one of the partitions. An assigned and utilized partition is illustrated in FIG. 1 by that portion of the memory 30 within the dashed lines that signify a logical processor. A similar discussion holds for computer slice 10B and memory 30B. When a processor element is assigned a partition, the memory within that partition may be accessed by the processor element by sending access requests to the I/O bridge 26 on the processor bus 28. The I/O bridge 26 checks that the processor element has permission to access the particular memory area, and if so, forwards the requests to the memory 30.

Still referring to FIG. 1, a computing system 1000 in accordance with embodiments of the invention also implements a persistent memory that utilizes one or more partitions of each memory 30. This persistent memory is illustrated in FIG. 1 by the dash-dot-dash rectangle 34. More particularly, in the two computer slice system of illustrative FIG. 1, one or more partitions or portions of memory 30A in combination with one or more partitions or portions of memory 30B are utilized as a persistent memory accessible to application programs by way of remote direct memory access communications through the communication network 36. The persistent memory 34 is accessible not only to application programs running in lock-step on the same computing system 1000, but also the persistent memory is accessible by application programs (whether fault tolerant or not) on other computer systems (not specifically shown) coupled to the communication network 36.

In accordance with at least some embodiments, synchronization logic 38 couples the persistent memory of the computer slices to the communication network 36. For purposes of redundancy, a persistent memory may have two dedicated synchronization logics. Synchronization logic 38 is similar in form and in structure to synchronization logics 18 and 20, and synchronization logic 38 may also perform tasks associated with implementing the persistent memory. In particular, synchronization logic 38 has the ability to do direct memory accesses to the memory from each computer slice assigned to be persistent memory 34. When the persistent memory 34 is being accessed by remote direct memory access (RDMA) requests, the synchronization logic 38 receives a single RDMA request from the communications network 36, replicates the request, and applies the replicated requests one each to each memory 30. Thus, although the persistent memory in this illustrative case comprises two physical memories in different computer slices, the persistent memory 34 appears to accessing programs as a single persistent memory unit. This feature is a significant advantage over related-art systems where the writing device has to manage multiple independent persistent memory devices by, for example, duplicating write requests.

In computing systems utilizing two computer slices (dual-modular redundant), such as FIG. 1, the persistent memory 34 thus has at least two complete copies of the information stored in the persistent memory, one copy each on the portion of the memory of each computer slice. In computing systems utilizing three computer slices (tri-modular redundant), the persistent memory 34 uses a portion of the physical memory from each of the three computer slices and thus maintains at least three complete copies of the information stored in the persistent memory. In tri-modular redundant persistent memories, the persistent memory is resilient to all faults. If one slice of a tri-modular redundant persistent memory experiences a fault, that fault manifests itself in the form of a voting error. In such a situation, the slice experiencing a fault is voted out, and the persistent memory continues with two slices, yet still appearing to accessing devices as a single persistent memory device. A dual-modular redundant persistent memory in accordance with embodiments of the invention is resilient to media faults and other self identifying faults (e.g., power failure of one slice). That is, if there is a voting error as between slices in a dual-modular redundant system, if other characteristics of operation of a particular slice indicate with high probability that a particular slice is at fault, then operation of the persistent memory continues with the remaining slice. Again, the accessing device is not privy to any voting error or action taken with respect to the voting error.

In the specific case of RDMA writes to the persistent memory 34, the illustrative synchronization logic 38 duplicates those writes, checks that the accessing device is authorized to use the particular portion of the persistent memory (either internally, or possibly by message exchange with one or more of the I/O bridges 26). If the accessing device is authorized to access the particular portion of the persistent memory, the synchronization logic 38 forwards the direct memory access write to each physical memory 30 by way of their respective I/O bridge 26. The I/O bridge may be busy with other reads and/or writes when the direct memory access write arrives, and thus the write may be stored in buffers in the I/O bridge 26 and actually written to the memory at some later time. Regardless of whether the write to each memory takes place immediately, or after some delay, after forwarding to the I/O bridges the data exists in on different computer slices, and therefore in different fault zones. After forwarding the writes to the I/O bridges, the synchronization logic 38 sends an acknowledgement to the device which sent the DMA write over the communications network 36, which may be any currently available or later developed communications network having RDMA capability, such as ServerNet, GigaNet, Infiniband, or Virtual Interface architecture compliant system networks (SANS). In the illustrative case of a ServerNet communication network, the acknowledgement message sent by the synchronization logic 38, because it is sent after the data is placed in separate fault zones, may be viewed by the requesting device as an indication that the data is safely stored, and may take only on the order of 10 microseconds to generate. Thus, the acknowledgement is generated quickly, and there is no need to send a higher level acknowledgement when the data is actually written.

In the case of RDMA read requests received by the synchronization logic 38 from the communications network 36, the synchronization logic 38 preferably performs direct memory access reads to each physical memory of the persistent memory 34 and provides the requested data to the voter logic 40 within the synchronization logic 38. Much like the voter logic 22 in the illustrative synchronization logic 18, voter logic 40 in synchronization logic 38 compares the read request data from each portion of the persistent memory 34, and if the read request data matches, provides a single set of read request data to the requesting device by way of network interface 42 and communications network 36.

Still referring to FIG. 1, consider for purposes of explanation duplicate copies of an application program running in the logical processor 12. Further consider that the duplicate copies of the application program wish to write data to a persistent memory. An application program executing in logical processor 12 accessing the persistent memory 34 is merely illustrative of any application program executing on any processor element (whether a single processor element or multiple processor elements operated in a fault tolerant mode) which has access to the persistent memory 34 by way of the communications network 36. The illustrative application program contacts another program known as the persistent memory manager (PMM). The PMM may be operating within the same logical processor, a different logical processor within the computing system 1000, or on any processor element accessible by way of the communications network 36. The PMM assigns the application program a portion of a persistent memory, such as persistent memory 34 in illustrative computing system 1000, but the persistent memory need not be co-located within the same computing system. As part of the assignment process, the PMM allocates a set of network virtual addresses and associates them with the assigned portion of the physical persistent memory. Further, the PMM may additionally set access control logic associated with the partition's virtual address such that only the desired application may access the allocated network virtual addresses.

Once a particular application program has been assigned a portion of a persistent memory by the PMM, the PMM need not be contacted again by the application program unless the size of the assigned area needs to be changed, or the application program completes its operation with the persistent memory and wishes to release the memory area. Thereafter, the application program executing in each processor element in the illustrative logical processor 12 generates an RDMA request to the persistent memory, which RDMA requests are voted in the voter logic 22 of synchronization logic 18, and a single RDMA request sent across the communications network 36.

When being assigned portions of a persistent memory, in some embodiments the application program in the logical processor is assigned a virtual address in the persistent memory space. The virtual address of the assigned persistent memory space may be translated into a network virtual address, e.g., by way of network interface 42 associated with persistent memory 34. The application program thus need not know the virtual address in the persistent memory space, but only the network virtual address. The persistent memory request thus traverses the illustrative network 36 and arrives at the target network interface, such as network interface 42 in synchronization logic 38. The network interface 42 and/or the synchronization logic 38 translate the network virtual address into physical memory addresses within each computer slice. In accordance with these embodiments of the invention, the PMM, regardless of its location, programs the various synchronization logics with information such that the various translations may be completed. In alternative embodiments of the invention, application programming interfaces within the logical processor may be accessed to perform the various translations from virtual address to network virtual address and/or to physical memory address. While a particular application program or other requesters may be assigned a contiguous set of virtual addresses in the persistent memory, the locations within the physical memory 30 need not be contiguous.

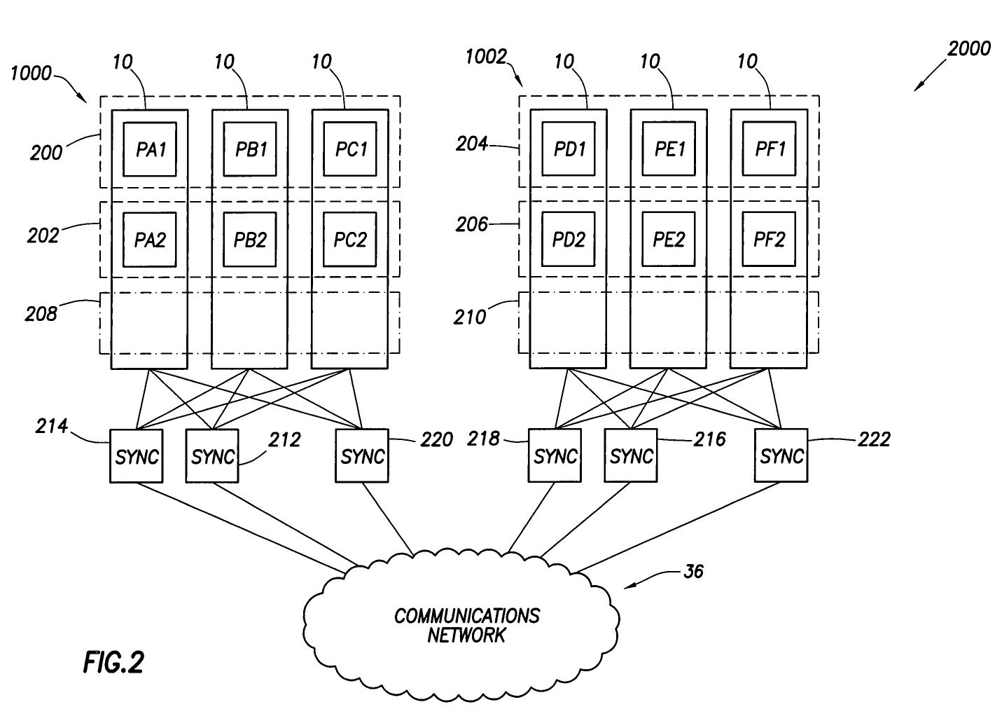

FIG. 2 illustrates alternative embodiments of the invention. In particular, FIG. 2 illustrates a computer complex 2000 comprising an illustrative two computing systems 1000 and 1002. Each computing system in the illustrative system of FIG. 2 comprises three computer slices 10, and is thus tri-modular redundant. The computer complex 2000 as illustrated also comprises four logical processors, with logical processors 200 and 202 implemented in computing system 1000, and logical processors 204 and 206 implemented in computing system 1002. Each logical processor is associated with a synchronization logic. Logical processor 200 may be associated with synchronization logic 212, logical processor 202 may be associated with synchronization logic 214, logical processor 204 may be associated with synchronization logic 216, and logical processor 206 may be associated with synchronization logic 218. Also in accordance with embodiments of the invention, each computing system has a portion of the physical memory partitioned to be a part of and participating in a persistent memory. In particular, computing system 1000 comprises persistent memory 208 and computing system 1002 comprises persistent memory 210. Each persistent memory is associated with a synchronization logic as discussed with respect to FIG. 1. In particular, persistent memory 208 may be associated with synchronization logic 220, and persistent memory 210 may be associated with synchronization logic 222. All the synchronization logics may be coupled by way of communications network 36.

FIG. 2 thus illustrates that a persistent memory in accordance with embodiments of the invention, though appearing to the outside world as a single memory device, may also be made up of physical memory from three separate computer slices. Moreover, application programs executing in logical processors of computing system 1000 may be assigned to and access, via the communications network 36, portions of the persistent memory 208 within computing system 1000, and also may be assigned to and access, by way of the communications network 36, portions of the persistent memory 210 of computing system 1002. The converse is also true, with application programs executing in logical processors on computing system 1002 having access, via the communications network 36, to the persistent memory 210 and/or the persistent memory 208. Moreover, FIG. 2 is illustrative of the fact that any application program that has access to the persistent memories 208 and 210 by way of the communications network 36 may utilize those persistent memories.

The systems of FIGS. 1 and 2 are merely illustrative. Computer slices in accordance with embodiments of the invention may have any number of processor elements configurable for operation in a logical processor. Moreover, though the illustrative FIGS. 1 and 2 show only one persistent memory within each computing system 1000 and 1002, any number of partitions may be made of the physical memory, and thus any number of persistent memories may reside within computing system 1000 and/or 1002. Further still, in computing systems having multiple persistent memories, either a single synchronization logic may be associated with all the persistent memories within the computing system, or each persistent memory may have a dedicated synchronization logic.

In accordance with embodiments of the invention, the various persistent memories are called “persistent” because the information contained in the persistent memory survives single points of failure. For example, in embodiments that implement persistent memory across multiple computer slices, the failure of a particular computer slice, because the information is still available in the non-failed computer slices, does not result in data loss. Moreover, for embodiments where the computer slices also utilize processor elements executing application programs, the persistent memory is not affected and the information that the application program wrote to the persistent memory 34 would still be available after restarting of the application program.

The persistent memory discussed to this point obtains some of its persistence in the form of duplication across multiple computer slices. In addition, or in place of, the persistence in the form of duplication across computer slices, the portion of a physical memory 30 that is assigned to the persistent memory may itself be non-volatile memory. Thus, some or all of the physical memory 30 assigned to a persistent memory within a computer slice may be magnetic random access memory (MRAM), magneto-resistive random access memory (MRRAM), polymer ferroelectric random access memory (PFRAM), ovonics unified memory (OUM), and flash memories of all kinds. Further still, the physical memory assigned to the persistent memory may be volatile in the sense that it loses data upon loss of power, but may be made to act as non-volatile by use of a battery-backed system.

Notwithstanding the persistence obtained by physical duplication and/or the use of non-volatile memories, each persistent memory may itself be made up of two or more partitions in each physical memory 30. In the case of a persistent memory comprising two partitions of a physical memory, each computer slice 10 maintains duplicate copies of the information in the persistent memory. Thus, in alternative embodiments of a persistent memory comprising the physical memory of two computer slices, with each physical memory having two partitions assigned to the persistent memory, four complete copies of the information in the persistent memory may be maintained.

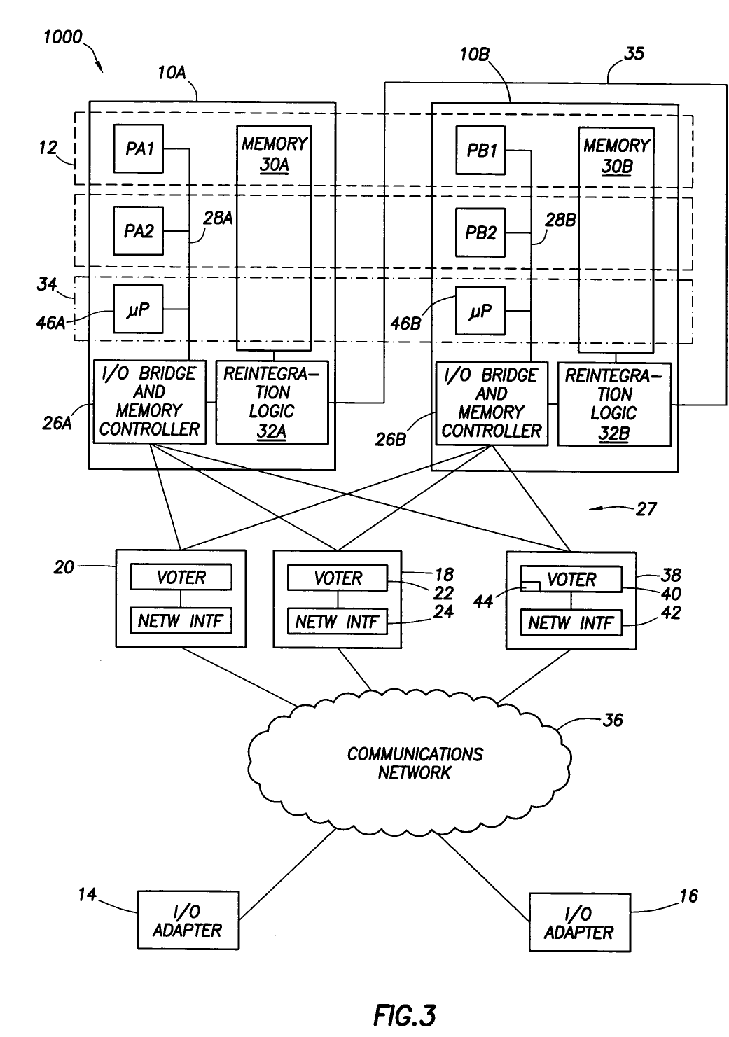

FIG. 3 illustrates alternative embodiments of the invention where the persistent memory 34 has associated therewith one or more processors elements. In particular, in these embodiments each computer slice 10, in addition to the other processor elements, has a processor element 46 associated with, and possibly dedicated to, operations regarding the persistent memory 34. The processor element 46 may couple to the memory 30 by way of the processor bus 28 and I/O bridge 26. In accordance with these embodiments of the invention, however, the processor element 46 does not necessarily execute application programs; but rather, each processor element 46 may be responsible for performing background (as viewed by the user) operations on its respective memory 30, and if necessary communicating information regarding the persistent memory in a non-voted fashion to the other processor elements in the persistent memory 34. For these reasons, the processor element 46 associated with a persistent memory need not have the same computing capability as the remaining processor elements in the computer slice that run application programs. In fact, the processor element 46 in each case may merely be a microcontroller dedicated to performing operations on its respective memory.

An illustrative operation that may be performed by the processor element 46 is a memory “scrubbing” operation. Scrubbing may take many forms. In some embodiments, scrubbing may involve each processor element checking for memory faults identifiable by embedded error correction codes. Thus, these scrubbing operations are independent of the memory in other slices of the persistent memory. In alternative embodiments, scrubbing may involve comparisons of memory locations from computer slice to computer slice. In particular, in these alternative embodiments each processor element 46 may periodically or continuously scan the one or more partitions in the computer slice 10 of the persistent memory 34, and compare gathered information to that of the companion processor element or processor elements in other computer slices of the computing complex 1000. Thus, processor elements 46 associated with a persistent memory 34 may communicate to each other in a non-voted fashion using the synchronization logics. For example, voter logic 40 of synchronization logic 38, illustrative of all voter logics associated with persistent memories, comprises a plurality of registers 44. The processor elements 46 within the persistent memory may exchange messages with other processor elements associated with a persistent memory by writing data (in a non-voted fashion) to the registers 44, and then requesting that the synchronization logic 38 inform the other processor elements 46 of the presence of data by sending those other processor elements an interrupt (or by polling). Consider, for example, processor 46A performing a memory scrubbing operation that involves calculating the checksum of a predetermined block of memory. Processor element 46A may communicate this checksum to processor element 46B by writing the checksum to one or more of the registers 44, and then requesting that the voter logic 40 issue an interrupt to the target processor element. Processor element 46B, receiving the interrupt and decoding its type, reads the information from the one or more registers 44 in the voter logic 40. If additional processor elements associated with the persistent memory are present, these processor elements may also receive the interrupt and may also read the data. Processor element 46B, calculating the checksum on the same block of memory in its physical memory 30B, may thus compare the checksums and make a determination as to whether the physical memories match. Likewise, processor element 46B may send a checksum for the predetermined block of memory to processor element 46A to make a similar determination. Thus, the processor elements 46 may periodically or continuously scan the partitions associated with the persistent memory 34 to proactively identify locations where the memories, that should be duplicates of each other, differ. If differences are found, corrective action may be taken, such as copying a portion of a physical memory 30 assigned to be the persistent memory 34 to corresponding locations in the second computer slice. The discussion now turns to correcting faults in the persistent memory.

Returning again to FIG. 1, when the memory of a particular computer slice experiences a fault (e.g., voting fault affecting just the persistent memory area of a particular computer slice, loss of power to the entire slice, or the replacement of a slice due to a service action) the persistent memory may still be operational based on the memory of the remaining, non-faulted computer slices. However, in accordance with embodiments of the invention, a portion or all of the memory of the faulted computer slice is preferably brought back to operational status by copying memory from a non-faulted computer slice to the faulted computer slice, with this copying taking place without interruption of use of the persistent memory. In some embodiments, copying of memory to correct a fault may utilize the reintegration logics 32. In other embodiments, copying of the memory may be done through the voter logic 38. Each of these alternatives will be discussed in turn; however, other mechanisms for copying or reintegrating the memory based on a particular hardware setup may be equivalently used.

As mentioned above, when not reintegrating memory, the reintegration logics 32 are transparent to memory operations. When used for memory reintegration, however, the reintegration logics work in concert to duplicate memory writes bound for one memory, and apply them to the second memory. Consider for purposes of explanation that computer slice 10A of FIG. 1 experiences a fault that requires a complete memory reintegration. To accomplish this task, the reintegration logic 32B is configured to not only forward memory transactions to memory 30B from I/O bridge 26B, but also to duplicate memory writes, and send those duplicated memory writes to the reintegration logic 32A along bus 35. Reintegration logic 32A is configured to decouple the 1/0 bridge 26A from the memory 30A, and to apply the duplicated memory writes to memory 30A. By reading and subsequently writing each memory location in memory 30B (e.g., by a communication network attached program, the PMM, or a program executing within the computer slice), memory 30B is copied to memory 30A. Once the copy is complete, both reintegration logics are configured to be transparent to memory operations, and computer slice 30A may be restarted such that the persistent memory 34 is again at least dual-modular redundant.

In alternative embodiments, the synchronization logic associated with the persistent memory may perform the memory copy. The synchronization logic may read each memory location of the non-faulted portion, and write each corresponding location in the faulted portion. Any writes received by the synchronization logic across the communication network 36 would also be passed to both memories 30A and 30B, but reads would be only from the non-faulted portions. Once the memory is copied, the previously faulted partition is again utilized.

The various embodiments discussed to this point partition memory of a computer slice such that the persistent memory uses at least one partition, and an application program executing on a processor element uses another partition; however, a “computer slice” in accordance with embodiments of the invention need not have a processor element executing programs, and instead may have either no processor elements (and thus comprising a memory controller, possibly an integration logic, and possibly a reintegration logic), or a processor with relatively low capability which may perform memory scrubbing operations as discussed above and/or implement programs to perform memory copying.

The above discussion is meant to be illustrative of the principles and various embodiments of the present invention. Numerous variations and modifications will become to those skilled in the art once the above disclosure is fully appreciated. It is intended that the following claims be interpreted to embrace all such variations and modifications.

What is claimed is:

1. A system comprising:
a first computer slice comprising a memory;
a second computer slice comprising a memory, the second computer slice coupled to the first computer slice by way of a communication network at least partially external to each computer slice; and
a persistent memory comprising at least a portion of the memory of each computer slice, the portion of the memory of the first computer slice storing a duplicate copy of data stored in the portion of the memory of the second computer slice;
wherein the persistent memory is accessible to an application program through the communication network.

2. The system as defined in claim 1 further comprising:
a logic device that couples each computer slice to the communications network; and
wherein the logic device receives a single direct memory access (DMA) write request over the communications network, duplicates the DMA write request, and provides the DMA write request one each to each memory.

3. The system as defined in claim 2 further comprising wherein, after providing the DMA write request one each to each memory, the logic device sends an acknowledgement over the communication network to a device that sent the single DMA write request.

4. The system as defined in claim 1 further comprising:
a logic device that couples each computer slice to the communications network; and
wherein the logic device receives a single direct memory access (DMA) read request over the communications network, duplicates the DMA read request, and provides the DMA read request one each to each memory.

5. The system as defined in claim 4 further comprising wherein the logic device compares read data from each computer slice precipitated by the DMA read requests, and the logic device forwards a single set of read data responsive to the DMA read request across the communications network.

6. The system as defined in claim 1 further comprising:
a third computer slice comprising a memory, the third computer slice coupled to the first and second computer slices by way of the communications network;
wherein the persistent memory further comprises at least a portion of the memory of each of the first, second and third computer slices, and wherein the portion of the memory of the third computer slice stores a duplicate copy of data stored in the portion of the memory of the second computer slice.

7. The system as defined in claim 6 further comprising:
a logic device that couples each computer slice to the communications network;
wherein the logic device receives a single direct memory access (DMA) write request over the communications network, duplicates the DMA write request, and provides the DMA write request one each to each memory.

8. The system as defined in claim 7 further comprising wherein, after providing the DMA write request one each to each memory, the logic device sends an acknowledgement over the communication network to a device that sent the single DMA write request.

9. The system as defined in claim 6 further comprising:
a logic device that couples each computer slice to the communications network;
wherein the logic device receives a single direct memory access (DMA) read request over the communications network, duplicates the DMA read request, and provides the DMA read request one each to each memory.

10. The system as defined in claim 9 further comprising wherein the logic device compares read data from each computer slice precipitated by the DMA read requests, and forwards a single set of DMA read data across the communications network.

11. The system as defined in claim 1 further comprising:
wherein the first computer slice further comprises a persistent memory processor element coupled to the memory of the first computer slice;
wherein the second computer slice further comprises a persistent memory processor element coupled to the memory of the second computer slice; and
wherein each processor accesses its respective memory to scrub for data errors.

12. The system as defined in claim 11 further comprising wherein the persistent memory processors directly access their respective memory, and exchange information about contents of their respective memory.

13. The system as defined in claim 1 further comprising wherein if the portion of the memory of first computer slice experiences a fault, the portion of the memory of the second computer slice is copied to the portion of the memory of the first computer slice.

14. A method comprising:
writing a single direct memory access (DMA) request targeting a persistent memory, the writing to a communication network;
receiving the single DMA request from the communication network; and then
duplicating the DMA request to have duplicate requests; and
providing the duplicate requests one each to a first memory and a second memory, wherein the first and second memories act as a single network accessible persistent memory.

15. The method as defined in claim 14 further comprising:
wherein writing further comprises writing a DMA read request;
voting read data provided from each of the first and second memories in response to the DMA read request; and
sending a single set of read data on the communication network if the read data provided from each of the first and second memories match.

16. The method as defined in claim 14 wherein receiving further comprises receiving the DMA request by a logic device associated with both the first and second memory.

17. The method as defined in claim 14 wherein duplicating further comprises duplicating by a logic device associated with both the first and second memory.

18. The method as defined in claim 14 further comprising:
wherein writing further comprises writing a DMA write request; and
returning, after the providing, an acknowledgement to a device which wrote the single DMA write request targeting the persistent memory, the acknowledgment indicating the write data is in separate fault zones.

19. A system comprising:
a first means for storing data;
a second means for storing data, the second means for storing coupled to the first means for storing by way of a means for computer network communication; and
a means for persistently storing data comprising at least a portion of the first and second means for storing data, the portion of the first means for storing data stores a duplicate copy of data stored in the portion of the second means for storing data;
wherein the means for persistently storing data is accessible to an application program means through the means for network computer communication.

20. The system as defined in claim 19 further comprising:
a means for coupling each of the means for storing data to the means for computer network communication; and
wherein the means for coupling receives a single direct memory access (DMA) write request over the means for computer network communication, duplicates the DMA write request, and provides the DMA write request one each to each means for storing data.

21. The system as defined in claim 20 further comprising wherein, after providing the DMA write request one each to each means for storing data, the means for coupling sends an acknowledgement over the means for computer network communication a device that sent the single DMA write request.

22. The system as defined in claim 19 further comprising:
a means for coupling each of the means for storing data to the means for computer network communication; and
wherein the means for coupling receives a single direct memory access (DMA) read request over the means for computer network communication, duplicates the DMA read request, and provides the DMA read request one each to each means for storing data.
